(19) United States
(12) Patent Application Publication
(10) Pub. No.: US 2014/0200752 A9
(43) Pub. Date: Jul. 17, 2014

(54) Meteorological Modelling Method for Calculating an Aircraft Flight Plan

(71) Applicants: Antoine Lacombe, Monferran Saves (FR); Xavier Blanchon, Toulouse (FR); François Coulmeau, Seilh (FR)

(72) Inventors: Antoine Lacombe, Monferran Saves (FR); Xavier Blanchon, Toulouse (FR); François Coulmeau, Seilh (FR)

(73) Assignee: Thales, Neuilly Sur Seine (FR)

(21) Appl. No.: 12/633,508

(22) Filed: Dec. 8, 2009

Related U.S. Application Data
(63) Continuation-in-part of application No. 11/627,879, filed on Jan. 26, 2007, now abandoned.

(30) Foreign Application Priority Data
Jan. 27, 2006 (FR) 06 00761
Dec. 9, 2008 (FR) 08 06902

(51) Int. Cl. G01C 23/00

(52) U.S. Cl. 701/8

(57) ABSTRACT

The invention relates to a meteorological modelling method for calculating an aircraft flight plan, the aircraft comprising a communication means and a navigation management system.

The method comprises at least the following steps: the communication means carries out the acquisition of meteorological prediction data related to waypoints in proximity to the nominal route in addition to the waypoints belonging to the nominal route, the navigation management system allocates by projection onto the current route of the aircraft the prediction data for the said waypoints not belonging to the current route, the navigation management system calculates the meteorological prediction data for the waypoints of the current route of the flight plan according to the prediction data allocated by projection onto the current route of the aircraft.

The invention is a modelling method for aircraft navigation management systems.

### PRIORITY CLAIM

This application claims priority to French Patent Application Number 08 06902, entitled Meteorological Modelling Method for Calculating an Aircraft Flight Plan, filed on Dec. 9, 2008.

### FIELD OF THE INVENTION

The field of the invention relates to schemes for calculating an aircraft's flight plan prediction data. In particular, the invention is a meteorological modelling method for calculating the flight plan, notably for modelling the profile of the winds of the navigation management system onboard the aircraft.

### BACKGROUND OF THE INVENTION

In recent years the increase in traffic and the resulting load on air traffic control has led to efforts to improve flight prediction systems so as to guarantee the safety but also the economic viability of air transport. Meteorological uncertainties are the main causes of time related vagaries when calculating flight plans. The navigation management systems of aircraft, more commonly called FMS for “Flight Management System”, calculate prediction data such as flight time and fuel consumption for example. These prediction data are determined by means of a calculation method taking the weather as one of the input factors, notably with data about winds, temperatures and pressure. These data have a big impact on the results of the prediction models. Indeed, for calculating the flight time of an aircraft for example, the ground speed taken into account is equal to the vector sum of the speed of the aeroplane and of the speed of the wind. Currently, the wind data provided to aeroplanes represent samples of points according to altitude slices.

In the environs of airports, it will for example be considered that the points of the takeoff and landing procedures are encompassed in a purely vertical wind model, based on altitude (at Iso altitude the wind is the same for the points of the procedure). On the “En route” or “cruising” part, a model which is at one and the same time vertical (based on altitude slices) and longitudinal (along the points of the flight plan) is generally considered, the longitudinal aspect being due to the fact that the wind can vary along the flight, all the more when travelling large distances.

For calculating wind profile over the route, from a departure airport to an arrival airport, weather ground stations transmit the wind data to the subscriber airlines, and the latter format them by altitude slices for the climb phase, the descent phase and the cruising flight phase so as to construct the paper pilot briefing or else to dispatch them to the aeroplanes in vocal or numerical form. The numerical wind data are transmitted according to the ARINC 702A standard (AEEC 702A “Flight Management System”) and are decoded aboard the aircraft by a communication management system, commonly called CMU for “Communication Management Unit”, or by another system such as the navigation management system, or else partially by one and then completed by the other. The aircraft navigation management system determines a predictive nominal route according to a lateral trajectory and a vertical trajectory to reach the arrival airport. This predictive nominal route is defined by a plurality of waypoints and by segments of trajectories between these waypoints, commonly called “legs”. The route can optionally contain elements other than the waypoints so as to construct the legs of the terminal procedures. These elements are standardized on board by ARINC 424 (AEEC 424: Navigation Data Base). The subsequent description will use the terms waypoint and leg which are customarily used in the field of aeronautics. Waypoints are catalogued in published navigation databases meeting the ARINC-424 standard which make it possible to define the most common aerial routes.

By collaboration of the positioning, guidance and navigation management systems, the aircraft follows the programmed trajectory. The navigation management system then calculates the prediction data in part as a function of the wind data for each waypoint of the aircraft's forecast nominal route. The entry of the meteorological data into the FMS for calculating the flight plan prediction data can be entered manually by the pilot or entered automatically by downloading the data by datalink.

The wind data are in general loaded aboard the aircraft before its departure for each waypoint of the nominal route or for a few elements, the aim being to forecast the fuel load to be carried and the flight time. These meteorological data constitute a predictive snapshot of the meteorological situation, the scope of which is reduced to the reference trajectory of the aircraft. The meteorological data transmitted aboard the aircraft represent a static forecast of the meteorological situation.

When an aircraft in flight encounters an unfavourable meteorological situation which is not in accordance with the forecast meteorological situation, for example a cloud under formation or a storm, the pilot may be constrained to deviate slightly from the reference trajectory. Likewise, the aeroplane may have deviated from its forecast trajectory for other reasons such as air traffic constraints, a diversion on account of a fault and/or an event on board such as a sick passenger, etc. From the moment the pilot leaves the nominal route, he is constrained to abandon the nominal flight plan and to compute an alternative flight plan.

In the prior state of the art, the alternative flight plan is built on the basis of just the meteorological data available in the aircraft, that is to say on the basis of the data which constitute the predictive snapshot. The FMS rejects the winds received by datalink if they do not correspond to a waypoint of the flight plan since the current specifications are based on a wind or a temperature per waypoint. These data which constitute the predictive snapshot are, by construction, unsuitable since they are values associated with places or with dates which do not correspond, a priori, to the waypoints of the alternative flight plan. Nevertheless, in spite of their unsuitability, they are meteorological data which are taken into account when determining the alternative flight plan by making an implicit assumption of stability of the data.

Taking erroneous meteorological data into account when establishing an aircraft route plot can have, at the margin, important consequences for flight safety, and more frequently, an impact on the pilot's ability to compute an alternative route that he will actually be able to follow right to the end without any fuel problem. The latter drawback is all the more deleterious as punctuality of civilian passenger transport aeroplanes is on the way to becoming an important issue for airlines and consequently for aircraft pilots because of the policy followed by air traffic control bodies which is aimed at optimizing the use of airports by imposing, potentially subject to financial sanction, precise dates of transit for passing predefined points in space.

In the future, it is envisaged that airlines will be provided with a winds publication service in the form of a three-dimensional mesh of the airspace. However, to set up such a service, future systems require the deployment of new ground structures for recovering and dispatching wind data as well as new devices onboard aircraft. There will also be a standardization step to allow an exchange between the various players on the ground and on board.

### SUMMARY OF THE INVENTION

An important aim of the invention is to alleviate the aforesaid problems. To achieve this aim, the invention proposes a meteorological modelling method for calculating an aircraft flight plan, the said flight plan being made up of a route comprising a plurality of waypoints interconnected by segments and each of the waypoints being associated with meteorological prediction data, the aircraft comprising a communication means carrying out the acquisition of the meteorological prediction data related to the waypoints and a navigation management system computing a nominal route before departure, as well as alternative routes while in flight, and guiding the aircraft on a trajectory following the current route of the flight plan. The method is characterized in that it comprises at least the following steps:

the communication means carries out the acquisition of meteorological prediction data related to waypoints in proximity to the nominal route in addition to the waypoints belonging to the nominal route;

the navigation management system allocates by projection onto points of the current route or of the trajectory of the aircraft the prediction data for the said waypoints not belonging to the current route;

the navigation management system calculates the meteorological prediction data for the waypoints of the current route or the trajectory of the flight plan according to the prediction data for the points, allocated by projection onto the current route of the aircraft.

Before the departure of the aircraft, the communication management system loads the wind data for waypoints of the nominal route but also the data relating to the waypoints of the geographical zone over which the aircraft has forecast it will operate.

A characteristic of the method is that the communication means carries out the acquisition of meteorological prediction data originating from a plurality of meteorological data sources. These data can originate from company data and/or from meteorological data suppliers and the meteorological prediction data are, in particular, wind data.

A characteristic making it possible to reduce the calculation times of the modelling method and to increase the precision of the flight plan prediction data is that the navigation management system selects prediction data related to waypoints whose distance of deviation from the nominal route of the flight plan is less than a distance threshold.

In one mode of realization, the distance threshold is parametrizable according to the number of prediction data acquired.

In one mode of realization, the value of the threshold is calculated dynamically along the nominal route as a function of the density of data acquired along the nominal route.

Advantageously, for the meteorological method of flight plan modelling, the current route of the aircraft is an alternative route to the nominal route. The invention makes it possible to recalculate a wind profile for an alternative route of the flight plan. The system having previously loaded wind data for the waypoints surrounding the nominal route, when the navigation management system computes a new flight plan for an alternative route, it uses as input data the wind data existing in the system for these new waypoints if they exist, though it is very improbable that they will have been loaded previously, and/or the wind data for the surrounding points.

The wind data allocated to the waypoints which have no wind data initially loaded arise from wind data situated in proximity to the waypoint and are the result of a calculation of a mean by weighting several waypoints. Several modes of implementing the step of allocating a wind datum value to a waypoint can be carried out and will be described subsequently in the description.

Another advantage is the possibility of defining a more precise wind profile sampling increment, since the invention makes it possible to allocate a wind prediction datum for every waypoint of the flight plan. By computing a flight plan route with numerous waypoints, the navigation system consequently has available to it a wind profile comprising a larger number of data samples.

Another advantage is that the invention does not require any additional ground structure providing for example a service of 3D meshing of the airspace an as to allocate a wind datum to every waypoint of the flight space surrounding the nominal route. Moreover, the aircraft is also not constrained to have specific onboard equipment, the modelling method possibly being carried out by the existing navigation management system and the wind data necessary for the calculation may also be recovered by the existing communication management system.

In one mode of calculation, the navigation management system allocates according to an orthogonal projection onto temporary points of the current route the value of the meteorological prediction data for the waypoints not belonging to the current route. The said points of the current route, on which meteorological prediction data are allocated, are points calculated temporarily for the duration of the flight and specifically for the meteorological modelling method.

In a second mode of calculation, the navigation management system allocates the value of the meteorological prediction data for waypoints not belonging to the current route to the waypoints of the current route not comprising any initially allocated meteorological prediction data.

The invention also relates to the navigation management system for an aircraft making it possible to calculate a flight plan between the departure airport and the arrival airport. The system is characterized in that to compute the flight plan prediction data, the said system carries out the meteorological modelling method such as described in any mode of realization above.

### BRIEF DESCRIPTION OF THE DRAWINGS

The invention will be better understood and other advantages will become apparent on reading the description which follows given without limitation and by virtue of the appended figures among which:

FIG. 1 represents a chart of a mode of progression of the method for calculating the predictive data of a flight plan for aircraft. This chart illustrates particularly the method of meteorological modelling of the wind data.

FIG. 2 illustrates the step of selecting the wind data around the current route of the flight plan of the aircraft, the stars representing the waypoints of the current route and the arrows representing wind data loaded for waypoints of the geographical zone surrounding the current route. The figure illustrates a first mode of selecting or filtering the wind data, carried out according to a threshold of distance with respect to the current route of the flight plan.

FIG. 3 represents a second mode of selecting the wind data, carried out according to a threshold of distance with respect to the waypoints of the current route.

FIG. 4 represents a first mode of allocating the wind data related to waypoints not belonging to the current route of the flight plan. The figure represents a mode of allocating the wind data by orthogonal projection onto the current route.

FIG. 5 represents a second mode of allocating the wind data related to waypoints not belonging to the current route of the flight plan. The figure represents a mode of allocating the wind data by projection onto the waypoints of the current route of the flight plan.

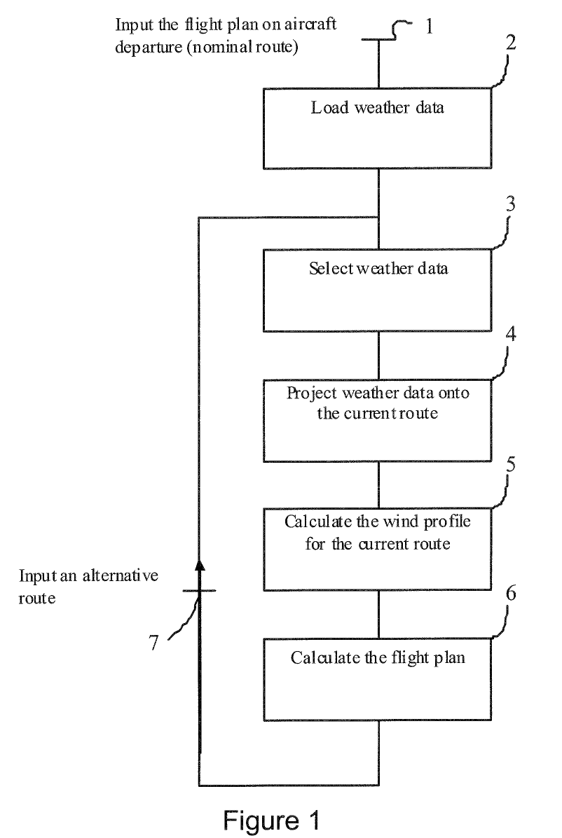

FIG. 1 illustrates the method of calculating the flight plan prediction data, in particular the part for modelling the wind prediction data. The onboard navigation management system, FMS, of an aircraft is the computer which determines the geometry of the trajectory profile in 4D, that is to say over the three-dimensional geographical space and time (via the speed profile). The FMS dispatches the guidance directives for following this profile to the pilot or to the automatic pilot. The functions computed by an FMS system are described in the ARINC 702 standard.

### DETAILED DESCRIPTION OF PREFERRED EMBODIMENT

In a first phase symbolized by step 1 of FIG. 1, at the moment of departure the flight plan is input by the pilot on the basis of data contained in the navigation database. The pilot enters several aircraft parameters: the weight, the flight plan, the span of cruising levels and one or more of the optimization criteria. These input data allow the functions of the FMS to calculate respectively the lateral trajectory and the vertical profile which minimizes the cost.

In a second phase represented by step 2, the meteorological data are loaded aboard the aircraft. The pilot can thereafter enter and/or receive by datalink (ACARS for “Aircraft Communications Addressing and Reporting System”) the meteorological data. The communication management unit CMU receives the messages coming from the ground and/or satellites. These messages are thereafter decoded so as to be utilized by the FMS. These data relate to:
the wind data on the climb phase relating to the strength and direction in altitude slices of up to five slices,
the wind data on the cruising points relating to the waypoints, the strength and direction in altitude slices of up to six slices,
the wind data on the descent phase relating to the strength and direction in altitude slices of up to six slices,
the data regarding the ground temperature, the temperature at cruising level and the tropopause altitude,
the data regarding the temperatures during cruising relating to the temperature, the altitude and the waypoints,
the data regarding the temperature at the destination.

The objective of loading the meteorological data is to collect the wind data which will be utilized to construct a wind profile over the current route of the flight plan. The current route corresponds to the nominal route computed before departure or to an alternative route. The loaded wind data can originate from a plurality of sources, a meteorological service related to the company and/or from a supplier of meteorological data. In contradistinction to the existing technical solutions, the loading of weather data relates to the geographical zone of the flight zone forecast, laterally as well as vertically, and not solely to the waypoints of the nominal route of the flight plan. The number of wind data loaded is fairly high since it represents the data for a geographical space wide enough to integrate any alternative routes that may possibly be used between the departure airport and the arrival airport.

Once the wind data have been loaded, in a third phase the method preferably carries out a step of selecting the data around the current route of the aircraft so as to optimize the calculations. Nevertheless, this step is optional since it can be avoided if the number of data loaded does not give rise in the following steps to an overly lengthy calculation process. The objective of step 3 of filtering the meteorological data is to optimize the calculations for allocating the meteorological data over the current route of the flight plan. It in fact makes it possible to reduce the calculation time for step 4 of allocating the data and step 5 of calculating the wind profile over the current route. The selection of the data can be carried out on the lateral profile and/or vertical profile so as to preserve only the winds close to the current route of the aircraft.

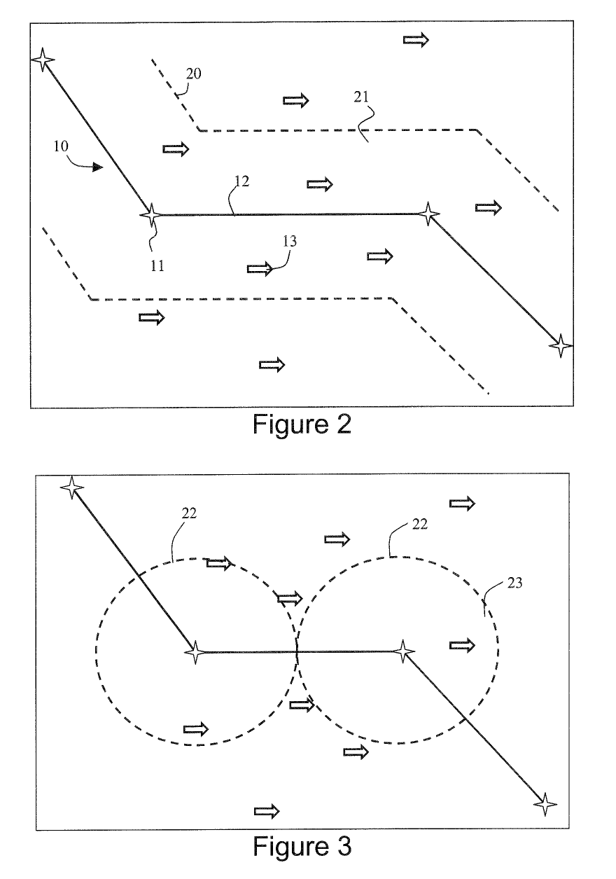

In a first mode of realization of the selection of the meteorological data, represented by FIG. 2, the navigation management system selects prediction data 13 related to waypoints 11 whose distance of deviation from the current route 10 of the flight plan is less than a distance threshold. The arrows 13 of the figure symbolize wind data on the flight plan. The stars 11 symbolize the waypoints of the current route of the flight plan. The current route is made up of legs 12. The distance threshold 20 delimits a selection zone 21 around the current route 10. The meteorological data related to a waypoint 13 located inside this zone are preserved for the calculation of the wind profile and the data related to a waypoint located outside the selection zone 21 are rejected. For the lateral profile and the vertical profile, the selection zone 21 is of the form of a rectangular cavity surrounding the route of the flight plan,

In a second mode of realization of the selection of the meteorological data, represented by FIG. 3, the navigation management system selects prediction data related to waypoints whose distance of deviation 22 from the waypoints of the current route of the flight plan is less than a distance threshold. The selection zones 23 are of the form of spheres, or circles on a plane, around the waypoints of the current route.

As a function of the wind data loaded in the course of step 1 of the method for calculating the flight plan, the selection may be more or less selective. In an optional characteristic of the method, the distance threshold is parametrizable according to the number of meteorological prediction data acquired. If few data are loaded during the data acquisition step, then the distance threshold 20 or 22 can be increased. In the converse case, the distance threshold is reduced. The objective of the filtering is to reduce the number of data samples for the calculations following so as to avoid a degradation of the wind profile calculation time without degrading the precision of the calculations.

In another filtering option, the distance threshold is dynamic as a function of the density of the prediction data according to the geographical zones of the current route of the flight plan. For zones which are dense in wind data, the distance threshold can be reduced and for zones of lower density the distance threshold can be increased, the distance threshold evolving during the progress of the flight plan.

In a fourth phase, the method of calculating the flight plan prediction data comprises a step 4 of allocating the value of the prediction data related to waypoints outside of the current route of the flight plan on points located on the current route. This projection-based allocation step makes it possible to obtain a wind profile over the whole of the flight plan. These points onto which the prediction data are projected can be waypoints 41 of the route of the flight plan or points calculated 31 temporarily for the duration of the flight and specifically for the calculation of the predictions of the flight plan.

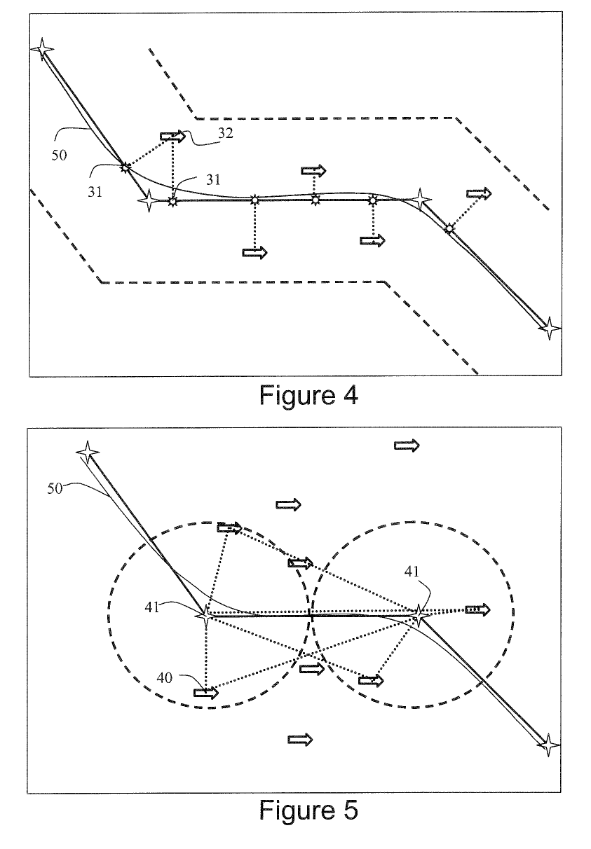

In FIGS. 4 and 5, the flight plan is a list of legs, also termed a discrete list. The segments of the flight plan are straight lines drawn between the legs of the flight plan, sometimes called the “pseudo-trajectory”. The trajectory 50 of the aircraft is a trajectory equivalent to curves linking the segments of the flight plan taking into account the transitions between the straight lines. The allocation calculation is the same for both these trajectories, but the projection point will be different if it falls in a transition in terms of position. The projection can be carried out on the pseudo-trajectory (10) of the flight plan or on the trajectory segments (50). In FIGS. 4 and 5, the trajectory 50 is represented with a slight shift with respect to the legs for better understanding of the figures.

According to a first mode of allocation illustrated by FIG. 4, the wind data 32 can be allocated by orthogonal projection onto the route to be followed creating points 31 which will be used in the calculation. The points 31 are not database waypoints, but calculated points used for the wind model of the predictions. These are pseudo-waypoints, waypoints created temporarily, over the time of the flight an as to demarcate wind data which are applied to the flight plan.

According to a second mode of allocation illustrated by FIG. 5, the wind data 40 can be allocated by projection onto the waypoints defining the current route of the flight plan. In this particular mode, weighting criteria are preferably assigned to each of the wind projections. These weightings can be used during the calculation of the prediction data for the winds on the waypoints or also over the whole of the profile of the flight plan. These weighting criteria can be the altitude of the wind measurement, the information source for the wind datum, the distance with respect to the flight plan, the distance with respect to the position of the aeroplane or the distance with respect to the waypoints of the flight plan. These examples of weighting criterion are cited by way of nonlimiting example.

In a fifth phase, the method of calculating the flight plan prediction data comprises a step 5 of calculating the wind data for the waypoints of the flight plan. These wind data of the flight plan make it possible to calculate a wind profile over the flight plan. This wind profile is thereafter intended to be utilized for the calculation of the whole of the flight plan prediction data, for example the speed profile, the vertical profile, the lateral profile, the weight profile and the profile of the transit times of passing the waypoints of the flight plan. With each waypoint or characteristic point of the vertical profile (“Top Of Climb”, “Top of Descent” for example) is associated a wind datum. The calculation of the wind profile can be carried out according to several schemes: the last wind prediction datum known on the current route can be used for the following waypoint, the closest projected wind prediction datum on the current route can be allocated to the waypoint of the current route, the computer can also carry out an interpolation between the last known prediction datum and the following prediction datum on the flight plan or the computer can allocate to a waypoint a datum predicting the wind by barycentric interpolation of the wind data projected initially onto the current route. The weighting criteria used in the previous step of allocating the data over the current route can be taken into account for the calculation.

The calculation scheme based on barycentric interpolation makes it possible to favour certain wind data with respect to other data so as to calculate the most reliable prediction resultant. Moreover, according to the latter calculation scheme the number of wind data used may be parametrizable statically or dynamically. This parameter influences the calculation times for generating the profile. The management of this parameter makes it possible to adjust the equilibrium between a reasonable calculation time and the precision of the wind datum calculated.

Once the wind profile has been determined over the whole of the current route, in a sixth phase the navigation system calculates in step 6 the prediction data for the various profiles of the flight plan, notably the transit times and fuel consumed for each element of the flight plan, that is to say for each “leg”. On the basis of the wind profile determined, it is possible to calculate the profiles (time, fuel for example) with respect to the predictions by using the wind profile. The calculation is carried out incrementally using a wind which evolves incrementally as a function of the progress of the aeroplane along the trajectory. In the calculation of the predictions, when the aeroplane passes a point, the prediction data, the time, the weight, as well as the wind used in the calculation at that moment are saved. The wind profile is displayed on the man-machine interface of the cockpit. The meteorological modelling method makes it possible to provide as input to the calculations a more reliable wind profile relating to the nominal route, since it benefits from a wider wind data sample.

The invention is particularly advantageous when an alternative route to the nominal route is input into the system, as represented in step 7 of FIG. 1. When loading the wind data before departure, there is little chance that the wind data for the waypoints of the alternative route will have been loaded. The invention nevertheless makes it possible to compute a wind profile for this new route since the modelling method is capable of determining a wind profile with data not belonging to the alternative route. In the case of the inputting of an alternative route to the nominal route, the modelling method executes all the steps 2 to 6 to determine a new flight plan according to this alternative route.

During the progression of the flight plan, the communication management system receives wind data by datalink. If the current route in the navigation management system is still the nominal route, the external authorities transmit the wind data corresponding to the waypoints of the current route. However, if the current route is an alternative route, the external authorities are not necessarily kept informed immediately of the waypoints of the alternative route. The invention nevertheless makes it possible to utilize the wind data not corresponding to the current route.

1. Meteorological modelling method for calculating an aircraft flight plan, the said flight plan being made up of a route comprising a plurality of waypoints interconnected by segments and each of the waypoints being associated with meteorological prediction data, the aircraft comprising a communication means carrying out the acquisition of the meteorological prediction data related to the waypoints and a navigation management system computing a nominal route before departure, as well as alternative routes while in flight, and guiding the aircraft on a trajectory following the current route of the flight plan, comprising at least the following steps:
the communication means carries out the acquisition of meteorological prediction data related to waypoints in proximity to the nominal route in addition to the waypoints belonging to the nominal route;
the navigation management system allocates according to an orthogonal projection onto temporary points distinct from the waypoints of the current route or of the trajectory of the aircraft the value of the meteorological prediction data for the waypoints not belonging to the current route;
the navigation management system calculates the meteorological prediction data for the waypoints of the current route or the trajectory of the flight plan according to the prediction data for the points, allocated by projection onto the current route of the aircraft.

2. Method according to claim 1, wherein the current route of the aircraft is an alternative route to the nominal route.

3. Method according to claim 1, wherein the communication means carries out the acquisition of meteorological prediction data originating from a plurality of meteorological data sources.

4. Method according to claim 3, wherein the navigation management system selects prediction data related to waypoints whose distance of deviation from the current route of the flight plan is less than a distance threshold.

5. Method according to claim 4, wherein the distance threshold is parametrizable according to the number of prediction data acquired.

6. Method according to claim 4, wherein the value of the threshold is calculated dynamically along the nominal route as a function of the density of data acquired along the nominal route.

7. Method according to claim 2, wherein the communication means carries out the acquisition of meteorological prediction data originating from a plurality of meteorological data sources.

8. Method according to claim 7, wherein the navigation management system selects prediction data related to waypoints whose distance of deviation from the current route of the flight plan is less than a distance threshold.

9. Method according to claim 8, wherein the distance threshold is parametrizable according to the number of prediction data acquired.

10. Method according to claim 8, wherein the value of the threshold is calculated dynamically along the nominal route as a function of the density of data acquired along the nominal route.

11. Method according to claim 1, wherein the points of the current route, on which meteorological prediction data are allocated, are points calculated temporarily for the duration of the flight and specifically for the meteorological modelling method.
